(19) United States
(12) Patent Application Publication
(10) Pub. No.: US 2005/0103592 A1
(43) Pub. Date: May 19, 2005

(54) Coupling used for torque limiting purposes

(76) Inventor: Klaus Kampf, Lohmar (DE)

Correspondence Address: HARNESS, DICKEY & PIERCE, P.L.C., P.O. BOX 828, BLOOMFIELD HILLS, MI, 48303, US

(21) Appl. No.: 10/963,063

(22) Filed: Oct. 12, 2004

(30) Foreign Application Priority Data
Oct. 13, 2003 (DE) 10348068.4

(51) Int. Cl. F16D 43/20

(52) U.S. Cl. 192/56.51

(57) ABSTRACT

A coupling has a coupling hub (1), a coupling sleeve (2), and driving dogs (60). The driving dogs 6 are adjustably guided in the coupling hub (1) transversely to a longitudinal axis (42) between a torque transmitting position and a disconnected position. Recesses (9) in a bearing bore (4) of the coupling sleeve (2) are engaged by the driving dogs (6) in their torque transmitting position for transmitting torque between the coupling sleeve (2) and the coupling hub (1). A first switching ring (43) is axially loaded by a first spring in a first direction. A second switching ring (44) is axially loaded by a second spring. A setting mechanism (23) pretensions the first spring (20). The switching rings (43, 44) allow the driving dogs (6) to be set to the disconnected position if a predetermined limit torque is exceeded.

### CROSS-REFERENCE TO RELATED APPLICATIONS

This application claims priority to German Patent Application Nos. 10348068.4 filed Oct. 13, 2003, which application is herein expressly incorporated by reference.

### FIELD OF THE INVENTION

The invention relates to a coupling for torque transmitting purposes, in particular, in a driveline for driving agricultural implements. The driveline has a coupling hub, a coupling sleeve arranged around the coupling hub, and driving dogs. The driving dogs, in a torque transmitting position, ensure the transmission of torque between the coupling hub and the coupling sleeve. In a disconnected position, the driving dogs prevent the transmission of torque.

### BACKGROUND OF THE INVENTION

A coupling is known from DE 195 38 35 C1. The driving dogs of the coupling are radially adjustably guided in the coupling hub between the torque transmitting position and the disconnected position. In the torque transmitting position, the dogs engage recesses in a bearing bore of the coupling sleeve. A first switching ring is provided which, in the direction of a longitudinal axis of the coupling, by a first supporting face, is axially loaded against first switching faces of the driving dogs. A spring is provided for loading purposes. The first switching faces of the driving dogs are each arranged on a plane which encloses an angle with the longitudinal axis. Accordingly, the driving dogs are loaded towards assuming their torque transmitting position. However, if a predetermined limit torque is exceeded, the driving dogs are permitted to move into the disconnected position. At the axially opposite end of the driving dogs, the driving dogs, via second switching faces, are supported against a second supporting face of a second switching ring. The second switching ring is axially supported against the coupling hub.

Thus, the first switching ring is axially moved when the driving dogs are transferred from the disconnected position into the torque transmitting position, with the first supporting face sliding along the first switching faces of the driving dogs. The driving dogs are transferred radially outwardly into the torque transmitting position. Furthermore, in the course of the movement, the second switching faces of the driving dogs slide on the second supporting face of the second switching ring, with the driving dogs also carrying out an axial movement.

A similar coupling is shown in DE 197 15 269 C1. Here, the coupling includes only one switching ring which axially loads the switching faces of the driving dogs. At the driving dog end facing away from the switching ring, the driving dogs are supported against a supporting face. The supporting face is arranged on a plane arranged at a right angle relative to the longitudinal axis of the coupling. This means that the driving dogs of the coupling are moved radially only when they are transferred from the disconnected position into the torque transmitting position. The driving dogs are not moved axially, although high friction forces generated between the driving dogs and the supporting face have to be overcome.

### SUMMARY OF THE INVENTION

It is an object of the present invention to provide a coupling of the initially mentioned type where the driving dogs do not carry out an axial movement when they are transferred from the disconnected position into the torque transmitting position. Also, the required switching forces are as low as possible.

In accordance with the invention, a coupling used for torque transmitting purposes, more particularly in the driveline for driving agricultural implements, comprises a coupling hub, a coupling sleeve and driving dogs. The coupling sleeve has a bearing bore which rotatably supports the sleeve on the coupling hub around a longitudinal axis. The driving dogs are adjustably guided in the coupling hub between a torque transmitting position and a disconnected position, transversely to the longitudinal axis. Recesses are provided in the bearing bore of the coupling sleeve and are engaged by the driving dogs in their torque transmitting position to transmit torque between the coupling sleeve and the coupling hub. A first switching ring is axially loaded by a first spring in a first direction with a first supporting face being supported against first switching faces of the driving dogs. This loads the driving dogs to enable the driving dogs to assume their torque transmitting position. A second switching ring, on a side of the driving dogs facing away from the first switching ring, is axially loaded by a second spring, in a direction opposed to the first direction, with a second supporting face being supported against second switching faces of the driving dogs. This loads the driving dogs to enable the driving dogs to assume their torque transmitting position. A setting mechanism is present to set the pretension of the first spring. The switching rings enable the driving dogs to be set to the disconnected position if a predetermined limit torque is exceeded.

The driving dogs are thus force-loaded on both sides by the first switching ring and the second switching ring. Since both switching rings are axially moved towards the driving dogs when the driving dogs are transferred into the torque transmitting position, an axial adjustment path need not be provided for the driving dogs. Furthermore, the driving dogs are not pressed axially against a radially extending face. Accordingly, only slight friction forces are generated inside the guiding mechanism of the driving dogs.

According to a preferred embodiment, the first spring is supported against the setting mechanism on the one hand and against the first switching ring on the other hand. The second spring is supported against the coupling hub on the one hand and against the second switching ring on the other hand. Thus, it is possible to set the pretension of the first spring. The pretension of the second spring does not necessarily need to be set. This can be predetermined by the design. Thus, it is possible, by design measures, to determine a pretension which corresponds to a certain limit torque, with the setting mechanism enabling precision setting.

The setting mechanism may be in the form of a nut which is threaded onto a thread of the coupling hub. To achieve short pretensioning paths, the spring is provided in the form of plate spring packages.

One possibility to prevent the coupling from being connected automatically after being disconnected, so that manual reconnection is necessary, is to provide a blocking mechanism. The blocking mechanism, when the coupling is in the disconnected position, holds at least one of the switching rings in a position which corresponds to the disconnected position of the driving dogs.

The blocking mechanism may be in the form of blocking elements and a locking element. The blocking elements are radially adjustably guided in an aperture of the first switching ring between a blocking position and a releasing position. The blocking elements, in a blocking position, engage a circumferential groove of the coupling hub and hold the first switching ring in a position which corresponds to the disconnected position of the driving dogs. Also, the blocking elements, in the releasing position, project outwardly beyond an outer circumferential face of the first switching ring.

The locking element is arranged around the first switching ring and is adjustably guided in the direction of the axis of rotation between a locking position and an unlocking position. The locking element is loaded by a spring to be able to assume the locking position where it covers the apertures and holds the blocking elements in the blocking position.

Furthermore, according to a preferred embodiment, in the disconnected position of the driving dogs, the first switching ring is supported against the first switching faces. The first switching faces are arranged on a plane which encloses an angle together with the longitudinal axis. In the disconnected position of the driving dogs, the second switching ring is supported against second switching face portions of the second switching faces. The second switching face portions are arranged on a plane at a right angle relative to the longitudinal axis.

Accordingly, in a first radial setting path of the driving dogs, starting from the disconnected position, the radial movement is carried out only by the spring force which acts on the first switching ring. The reconnection torque is thus kept at a low level. Only in a second setting path portion towards the torque transmitting position, are the driving dogs affected by those spring forces which act on both switching rings, so that the set limit torque is achieved.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Two preferred embodiments will be explained below in greater detail with reference to the drawings wherein:

FIG. 1 is a longitudinal section view through a first embodiment of an inventive coupling, with the driving dogs in the torque transmitting position.

FIG. 2 is a cross-section view along line 2-2 through the coupling according to FIG. 1.

FIG. 3 is a longitudinal section view like FIG. 1, with the driving dogs in the disconnected position.

FIG. 4 is a cross-section view along line 4-4 through the coupling according to FIG. 3.

FIG. 5 is a longitudinal section view through a second embodiment of an inventive coupling, with the driving dogs in the torque transmitting position.

FIG. 6 is a cross-section view along line 6-6 through the coupling according to FIG. 5.

FIG. 7 is a longitudinal section view like FIG. 5, with the driving dogs in the disconnected position, and

FIG. 8 is a cross-section view along line 8-8 through the coupling according to FIG. 7.

### DETAILED DESCRIPTION OF THE PREFERRED EMBODIMENTS

The following description of the preferred embodiment(s) is merely exemplary in nature and is in no way intended to limit the invention, its application, or uses.

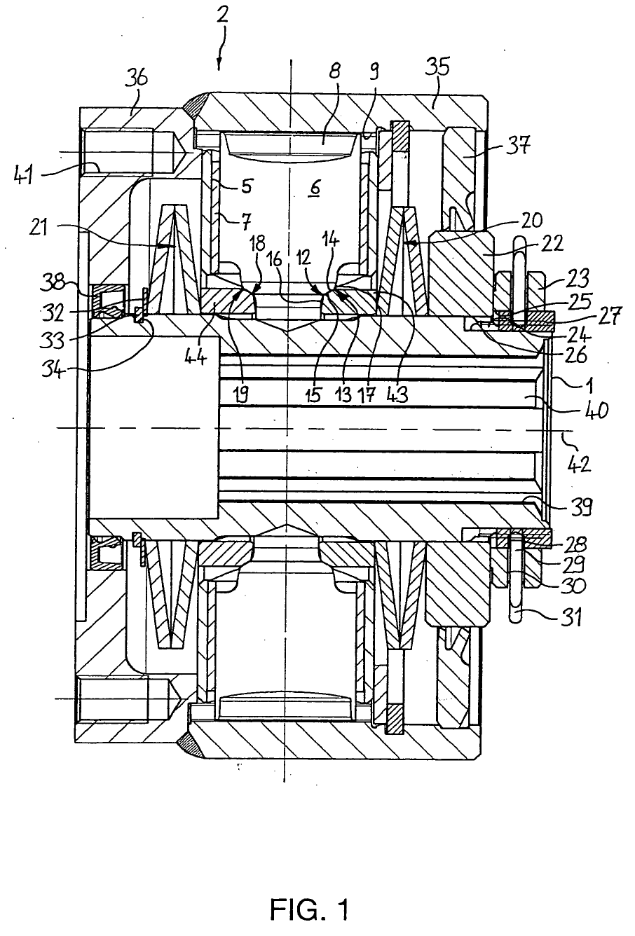

The first embodiment of an inventive coupling is shown in FIGS. 1 to 4 which will be described jointly below.

The figures show a coupling hub 1 with a coupling sleeve 2 rotatably arranged around the coupling hub and a longitudinal axis 42. The coupling hub 1 includes a bearing face 3 in the form of an outer circumferential face which is designed to support the coupling hub 1 inside the coupling sleeve 2.

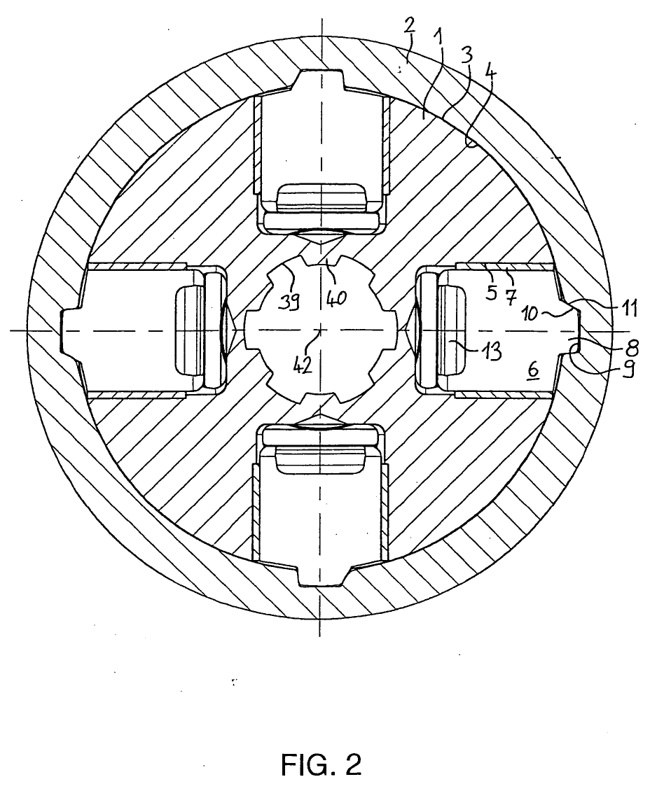

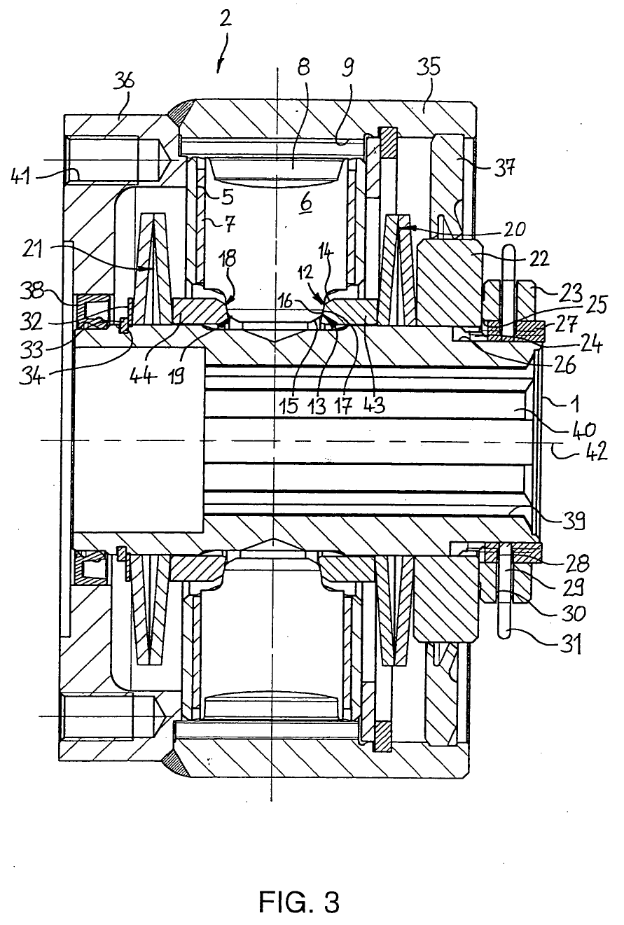

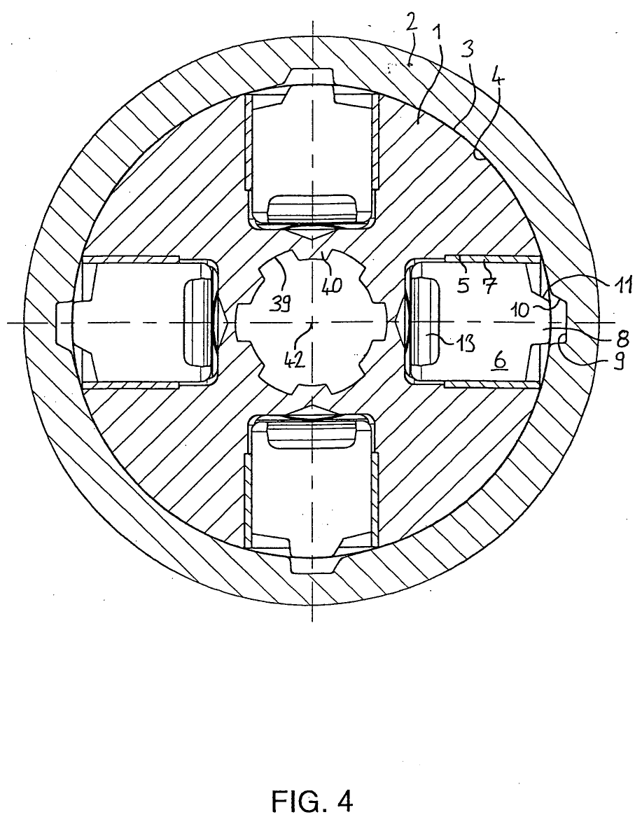

The coupling hub 1 includes four radial bores 5 which radially adjustably guided driving dogs 6 between a torque transmitting position, illustrated in FIGS. 1 and 2, and a disconnected position, illustrated in FIGS. 3 and 4. Sliding bushes 7 are provided to guide the driving dogs 6 accommodated in the radial bores 5.

In the torque transmitting position (FIG. 1 and FIG. 2), head portions 8 of the driving dogs 6 are arranged in recesses 9 of the bearing bore 4. The recesses 9, in the form of grooves, are arranged so as to extend parallel to the longitudinal axis 42 of the coupling. The recesses 9 form first torque transmitting faces 10 to enable the transmission of torque between the coupling hub 1 and the coupling sleeve 2. The first torque transmitting faces 10 are contacted by second torque transmitting faces 11 of the head portions 8 of the driving dogs 6 when the driving dogs 6 are in the torque transmitting position. The first torque transmitting faces 10 and the second torque transmitting faces 11 are orientated to extend in the same direction while being arranged at an angle relative to the setting direction of the driving dogs 6. Thus, when a predetermined limit torque is exceeded, the driving dogs 6 are pressed radially inwardly out of the recesses 9.

A first switching ring 43 is arranged around the coupling hub 1. The first switching ring 43 has a first supporting face 12 which is held in contact with first switching faces 13 of the driving dogs 6. In the torque transmitting position of the driving dogs 6, as illustrated in FIG. 1, a first supporting face portion 14 of the first supporting face 12 is in contact with a first switching face portions 15 of the first switching faces 13. In the disconnected position of the driving dogs 6, as illustrated in FIG. 3, a second supporting face portion 16 is in contact with second switching face portions 17 of the first switching faces 13. The first switching face portions 15 are each arranged on planes which, together with the longitudinal axis 42, enclose a first angle which is open towards the first switching ring 43. The second switching face portions 17 are also each arranged on planes which, together with the longitudinal axis 42, enclose a second angle which is open towards the second switching ring 44. The second angles are smaller than the first angle enclosed by the first supporting face portions 14 and the longitudinal axis 42.

The first supporting face portion 14 is arranged such that, in the torque transmitting position, it rests in a planar way, on the first switching face portions 15. The second supporting face portion 16 is designed such that, in the disconnected position of the driving dogs 6, it rests, in a planar way, on the second switching face portions 17.

Thus by applying force to the first switching ring 43 towards the driving dogs 6, it is ensured that the latter are loaded towards the torque transmitting position. As a result of the different angular arrangements of the first switching face portions 15 and the second switching face portions 17, the force loading the driving dogs 6 towards the torque transmitting position, starting from the disconnected position, is initially smaller and increases towards the torque transmitting position. Thus, after the coupling has been disconnected due to exceeding the limit torque, it is ensured that the torque required for reconnection clearly has to be lower than the limit torque. Thus, automatic reconnection of the coupling only takes place at low torque values which are clearly lower than the limit torque.

Furthermore, on the side of the driving dogs 6, facing away from the first switching ring 43, a second switching ring 44 is provided. The second switching ring 44 has a second supporting face 18 which is held in contact with the second switching faces 19 of the driving dogs 6. The second supporting face 18 and the second switching faces 19 are designed to correspond to the first supporting face 12 and the first switching faces 13.

The first switching ring 43 is loaded towards the driving dogs 6 by a first plate spring package 20 and the second switching ring 44 by a second plate spring package 21. The first plate spring package 20 is axially supported against the first switching ring 43 and a setting ring 22. The setting ring 22, in turn, is axially supported against a nut 23. The nut 23 is threaded onto an outer thread 24 of the coupling hub 1. The nut 23 includes circumferentially distributed longitudinal grooves 25 which are open towards the coupling hub 1. The outer thread 24 has corresponding circumferentially distributed longitudinal grooves 26. Thus, the nut 23 can be rotated into a rotational position where the longitudinal grooves are aligned relative to one another and an adjustment keys 27 can be slid into the grooves. Thus, accidental rotation of the nut 23 is prevented. This is particularly important since the pretension of the first plate spring package 20 is set by the nut, which as result, the limit torque is defined. This type of arrangement, effected via the adjustment keys 27 and the longitudinal grooves 25, 26, prevents an unintentional adjustment of the limit torque. Radial bores 28 are engaged by ends 29 of a leg spring 31, which ends 29 extend through radial bores 30 in the nut 23, to secure the adjustment keys 2 in place.

The second plate spring package 21 is axially supported against the second switching ring 44 and, via an intermediate disc 32, against a securing ring 33. The securing ring 33 is positioned in a circumferential groove 34 of the coupling hub 1. A basic setting of the pretension of the second plate spring package 21 can be achieved by using different intermediate discs 32 with different thicknesses.

The coupling sleeve 2 includes a housing 35 and a cover 36 which are welded to one another. A sealing ring 37 is arranged between the housing 35 and the setting ring 22 to seal the interior of the coupling. Further, a sealing ring 38 is provided between the cover 36 and the coupling hub 1 to seal the interior of the coupling. The coupling hub 1 has a central axial bore 49 to connect the coupling hub 1 with a component of a driveline. The central axial bore 49 defines a longitudinal teeth 40 to provide a rotationally fast connection with a shaft journal. The cover 36 of the coupling sleeve 2 can be connected to a further component of a driveline via threaded bores 41.

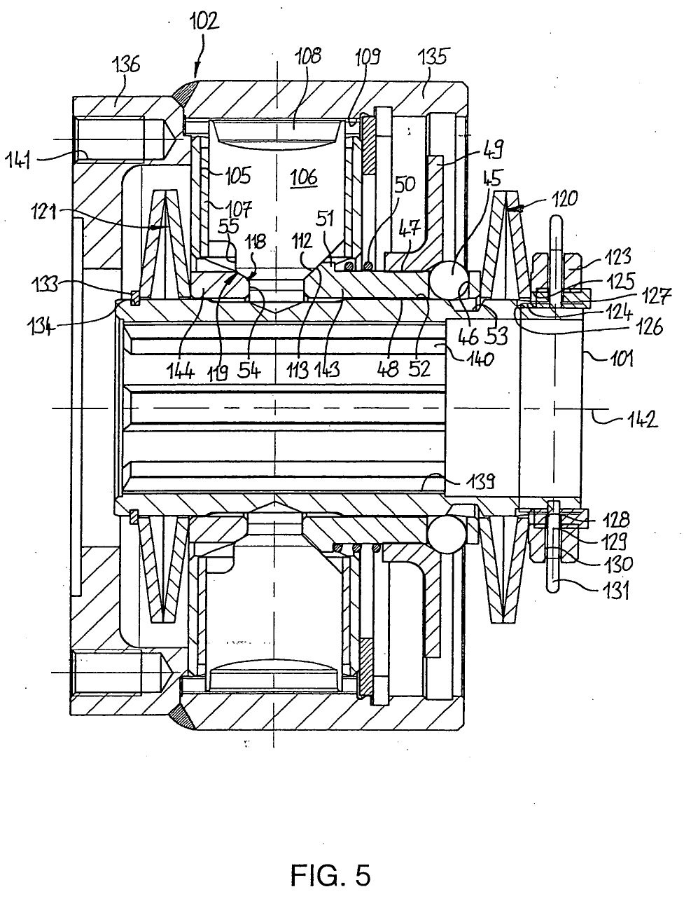

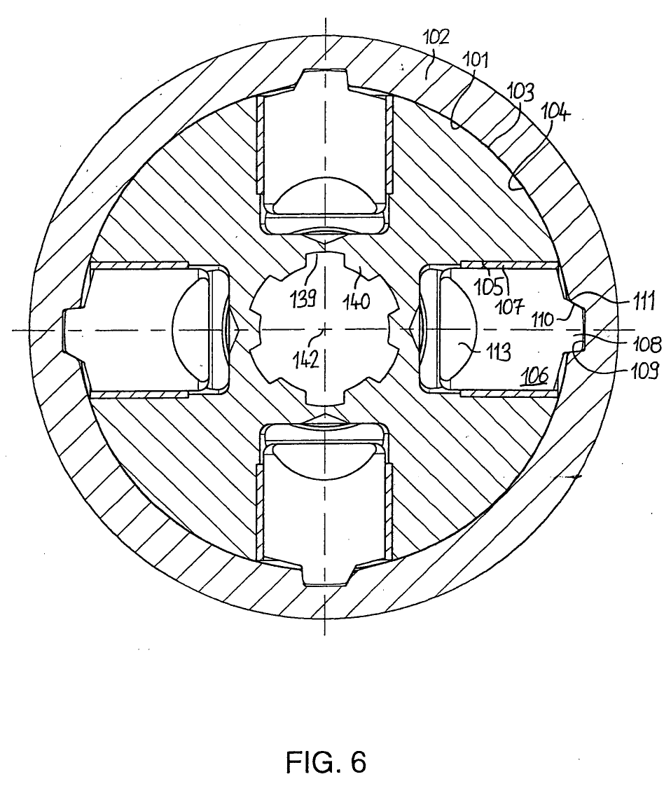

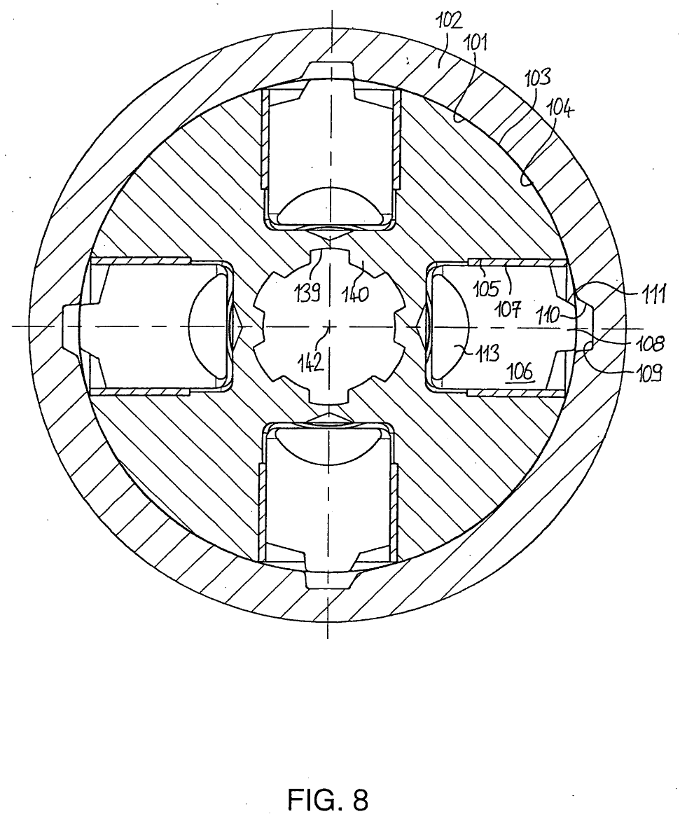

FIGS. 5 to 8 show a second embodiment of an inventive coupling. Any components which are identical to those used in the first embodiment have been given reference numbers which are increased by the value of 100.

In the second embodiment, blocking mechanism are provided which prevent automatic reconnection of the coupling after it has been disconnected due to exceeding a limit torque.

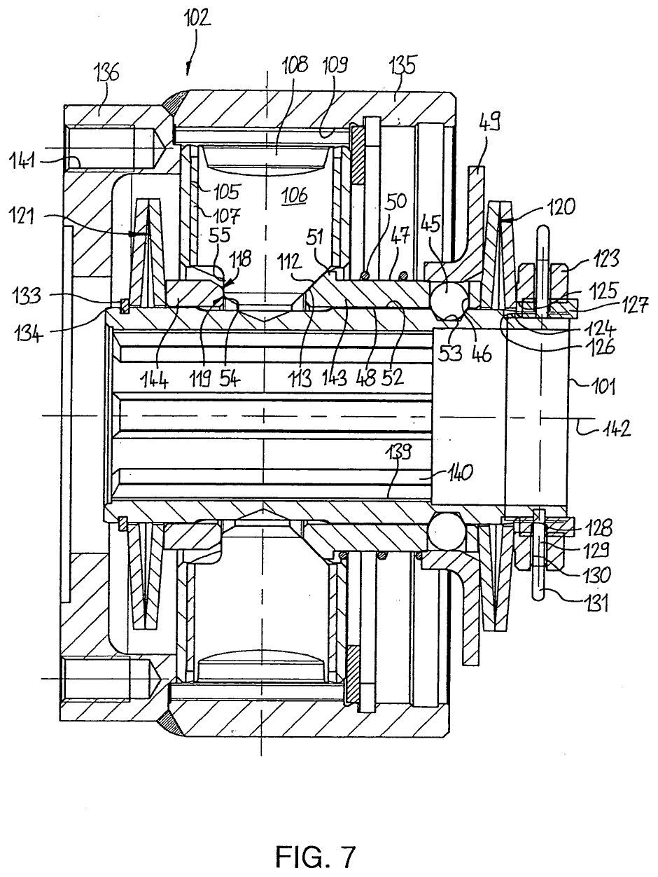

The blocking mechanism includes blocking elements 45 in the form of balls which are adjustably arranged in apertures 46. The apertures 46 are in the form of radially extending through-bores in the first switching ring 43 between a blocking position and a releasing position. In the torque transmitting position of the driving dogs 106 illustrated in FIG. 5, the blocking elements 45 are in the releasing position. Here, the blocking elements 45 project radially from an outer circumferential face 47 of the first switching ring 143 and are flush with an inner circumferential face 48 of the first switching ring 143. In the torque transmitting position of the driving dogs 106, the first switching ring 143 is axially displaced towards the driving dogs 106, with the blocking elements 45 held in contact with an outer face 52 of the coupling hub 101. A locking element 49 in the form of a sleeve is arranged around the first switching ring 143 and is axially loaded against the blocking elements 45. A pressure spring 50 is loaded against a shoulder 51 of the first switching ring 143 and against the blocking elements 45. The locking element 49 is loaded in the direction extending away from the driving dogs 106 against the blocking elements 45. In the disconnected position of the driving dogs 106, which is illustrated in FIG. 7, the first switching ring 143 is in a position displaced away from the driving dogs 106. Here, the blocking elements 45 project inwardly from the inner circumferential face 48 of the first switching ring 143 and are positioned in a circumferential groove 53 of the coupling hub 101. In the blocking position, the blocking elements 45 are flush with the outer circumferential face 47 of the first switching ring 143. Thus, the locking element 49 is axially displaced into a position covering the apertures 46. The second switching ring 144 is thus held in the position which corresponds to the disconnected position of the driving dogs 106.

To ensure that the second switching ring 144 does not load the driving dogs 106 towards their torque transmitting position, both the second supporting face portion 54 of the second supporting face 118 and the second switching face portion 55 of the second switching face 119 are arranged on a plane which is arranged at a right angle relative to the longitudinal axis 142. This means that when the driving dogs 106 are in the disconnected position, no radially acting force is applied to the driving dogs 106 as long as the blocking elements 45 are held in the blocking position.

The description of the invention is merely exemplary in nature and, thus, variations that do not depart from the gist of the invention are intended to be within the scope of the invention. Such variations are not to be regarded as a departure from the spirit and scope of the invention.

1. A coupling, for torque limiting purposes, comprising:
a coupling hub;
a coupling sleeve having a bearing bore rotatably supported on the coupling hub around a longitudinal axis;
driving dogs being adjustably guided in the coupling hub, transverse to the longitudinal axis, between a torque transmitting position and a disconnected position;
recesses in the bearing bore of the coupling sleeve, said recesses engaged by the driving dogs in their torque transmitting position for transmitting torque between the coupling sleeve and the coupling hub;
a first switching ring axially loaded by a first spring mechanism in a first direction, with a first supporting face supported against first switching faces of the driving dogs and said first switching ring loads the driving dogs to enable said driving dogs to assume their torque transmitting position;
a second switching ring being arranged on a side of the driving dogs facing away from the first switching ring, said second switching ring is axially loaded by a second spring mechanism, in a direction opposed to the first direction, with a second supporting face supported against second switching faces of the driving dogs and said second switching ring loads the driving dogs to enable said driving dogs to assume their disconnected position; and
a setting mechanism to set pretension of the first spring mechanism;
wherein the switching rings enable the driving dogs to be set to the disconnected position if a predetermined limit torque is exceeded.

2. A coupling according to claim 1, wherein the first spring mechanism being supported against the setting mechanism on the one hand and against the first switching ring on the other hand and the second spring mechanism supported against the coupling hub on the one hand and against the second switching ring on the other hand.

3. A coupling according to claim 2, wherein the setting mechanism provided in the form of a nut threaded onto an outer thread of the coupling hub.

4. A coupling according to claim 1, wherein the first and second spring mechanism are in the form of plate spring packages.

5. A coupling according to claim 1, wherein a blocking mechanism, when the coupling is disconnected, holds at least one of the switching rings in the position which corresponds to the disconnected position of the driving dogs.

6. A coupling according to claim 5, said blocking mechanism further comprising:
blocking elements being radially adjustably guided in an aperture of the first switching ring between a blocking position and a releasing position, said blocking elements, in the blocking position, engage a circumferential groove in the coupling hub and hold the first switching ring in the position which corresponds to the disconnected position of the driving dogs, said blocking elements, in the releasing position, project outwardly beyond an outer circumferential face of the first switching ring; and
a locking element arranged around the first switching ring, said locking element being adjustably guided in the direction of the longitudinal axis between a locking position and an unlocking position, said locking element is loaded, by a spring mechanism, for assuming the locking position where said locking element covers the apertures and holds the blocking elements in the blocking position.

7. A coupling according to claim 6, wherein said first switching ring, in the disconnected position of the driving dogs, is supported against the first switching faces, said first switching faces each arranged on a plane which encloses an angle with the longitudinal axis; and
said second switching ring, in the disconnected position of the driving dogs, is supported against second switching face portions of the second switching faces, wherein the second switching face portions are arranged on a plane extending at a right angle relative to the longitudinal axis.
